(19) United States
(12) Patent Application Publication
(10) Pub. No.: US 2013/0179489 A1
(43) Pub. Date: Jul. 11, 2013

(54) ACCELERATING WEB SERVICES APPLICATIONS THROUGH CACHING

(71) Applicants: Marcus Isaac Daley, Highland, UT (US); Aleh Hanin, Saint Petersburg City (RU); Ihar Melnikau, Saint Petersburg City (RU); Nate Zobrist, Orem, UT (US)

(72) Inventors: Marcus Isaac Daley, Highland, UT (US); Aleh Hanin, Saint Petersburg City (RU); Ihar Melnikau, Saint Petersburg City (RU); Nate Zobrist, Orem, UT (US)

(21) Appl. No.: 13/347,565

(22) Filed: Jan. 10, 2012

(51) Int. Cl. G06F 15/16

(52) U.S. Cl. 709/203

(57) ABSTRACT

Embodiments of a service acceleration system are described, wherein the service acceleration system accelerates messages between a client computing system and a server computing system. For at least some messages over a computing network between the client computing system and the server computing system, the service acceleration system can replace full messages with identifiers. The service acceleration system can then translate the identifiers into full messages before final processing of the messages by the client computing system or server computing system.

By sending identifiers instead of full messages, the full messages do not need to be sent over at least part of the computing network. For example, rather than sending multiple data packets (e.g., TCP, IP, UDP, etc.) for the full message, the service acceleration system can send a single data packet having the message identifier over part of the computing network.

### BACKGROUND

This disclosure generally relates to systems and methods for accelerating responses from a web service, and more particularly, reducing the traffic between the web service and a client.

### DESCRIPTION OF THE RELATED ART

As more and more people are connected to the Internet, companies are making more web services available to users. Web services can refer to services that are delivered to a consumer or business over the Internet or other computing network. Web services provide the benefit of allowing customers access to applications and data over a computing network, from a variety of devices, without necessarily installing any specialized software on the devices. For example, many web services are accessible using a web browser or other web service interface, though some web services may utilize plug-ins or other add-ons for the web browser.

Typically, web services are provided using a client-server architecture. The client-server architecture partitions tasks or workloads between the providers of a resource or service, called servers, and service requesters, called clients. Often clients and servers communicate over a computer network on separate hardware, though both client and server may reside in the same system, in some instances. Typically, a server system can be a computing system that is running one or more server programs which share their resources with clients. A client can request content, services or other resources from the server system. Typically, clients initiate communication sessions with the server system, which awaits incoming requests.

### SUMMARY

In some embodiments, a service acceleration system accelerates request and/or response messages between a client computing system and a server computing system. For at least some messages over a computing network between the client computing system and the server computing system, the service acceleration system can replace full messages with identifiers. The service acceleration system can then translate the identifiers into full messages before final processing of the messages by the client computing system or server computing system.

By sending identifiers instead of full messages, the full messages do not need to be sent over at least part of the computing network. For example, rather than sending multiple data packets (e.g., TCP, IP, UDP, etc.) for the full message, the service acceleration system can send a single data packet having the message identifier over part of the computing network.

### BRIEF DESCRIPTION OF THE DRAWINGS

FIG. 1A is a block diagram of a service acceleration system that is configured to accelerate traffic between client computing systems and servers;

FIG. 1B is a block diagram illustrating an embodiment of cache updating in the service acceleration system of FIG. 1A;

FIG. 2A illustrates a flowchart of an embodiment of a process for responding to a web services request;

FIG. 2B illustrates a flowchart of an embodiment of a process for reducing a web service request;

FIG. 3 illustrates a flowchart of an embodiment of a process for requesting a web service response;

FIG. 4 illustrates an embodiment of an accelerator computing device; and

FIG. 5 illustrates an embodiment of the service acceleration system that includes reverse proxy functionality.

### DETAILED DESCRIPTION

While providing web services on a computer network, such as the Internet, provides high availability for a web service, using the computer network can reduce the responsiveness of the service. Because the web service is operating on the computer network and messages travel over the computing network, the responsiveness of the web service becomes subject to the speed of the computer network. Typically, the speed of the computer network can be affected by both the bandwidth and the latency of the network. Bandwidth can refer to the data rate supported by a network connection or interface while latency can refer to any of several kinds of delays typically incurred in processing of network data. As traffic from a client travels to a server over the network, the responsiveness of the service is affected by how fast the data packets comprising the traffic can travel between the client and the server.

Performance is an important concern for any application, but becomes even more important when the application is a web service, which may be accessed by thousands of clients simultaneously. One way of increasing performance is by reducing the amount of traffic between the client and the server. Another way of increasing performance is by having a proxy server respond to at least some of the requests transmitted to the server, whereby responding decreases the load on the on server and/or reduces distance the response travels on the network. Another way of increasing performance is by sending less traffic over the slower parts of a computing network. For example, typically message traffic over a wide area network is slower than traffic over a local area network. In one embodiment, the message identifiers can be transmitted over the wide area network and only converted to full messages once the message identifiers reach the typically faster local network.

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the systems and methods herein described.

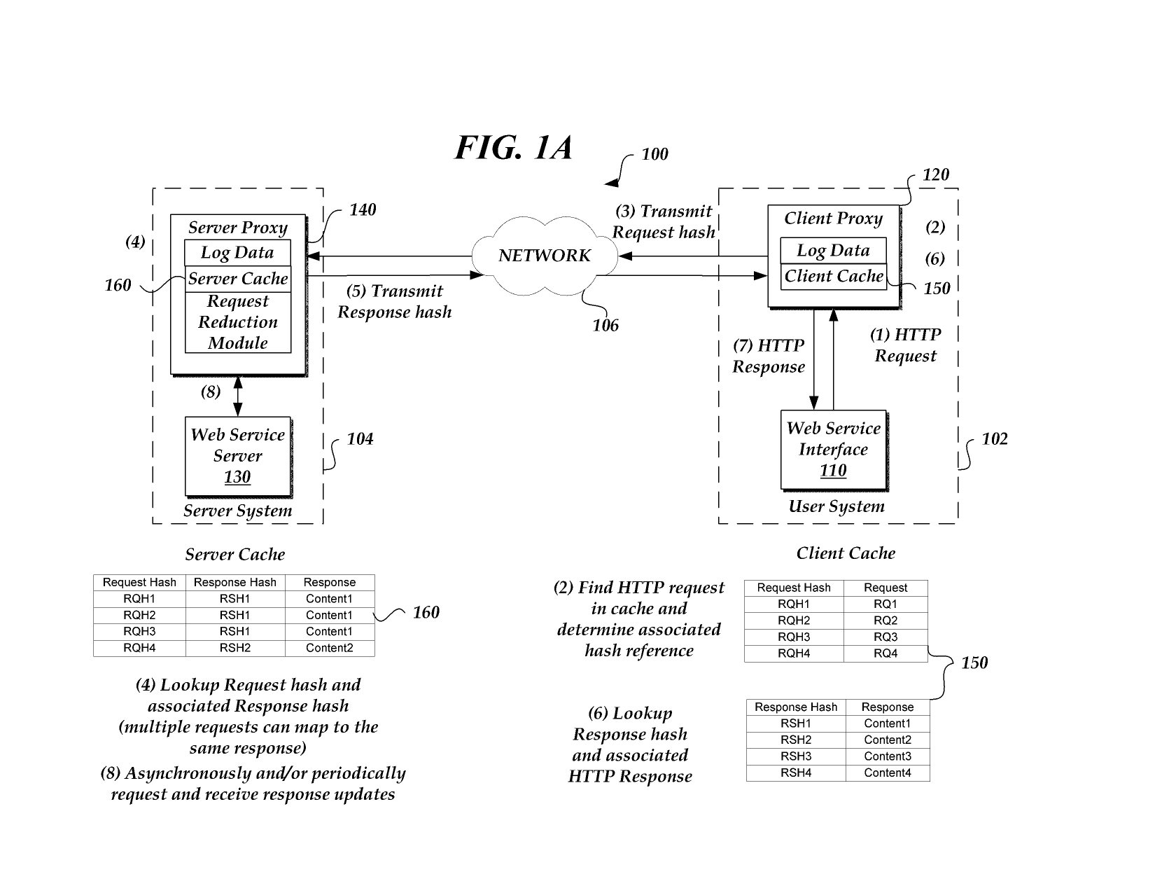

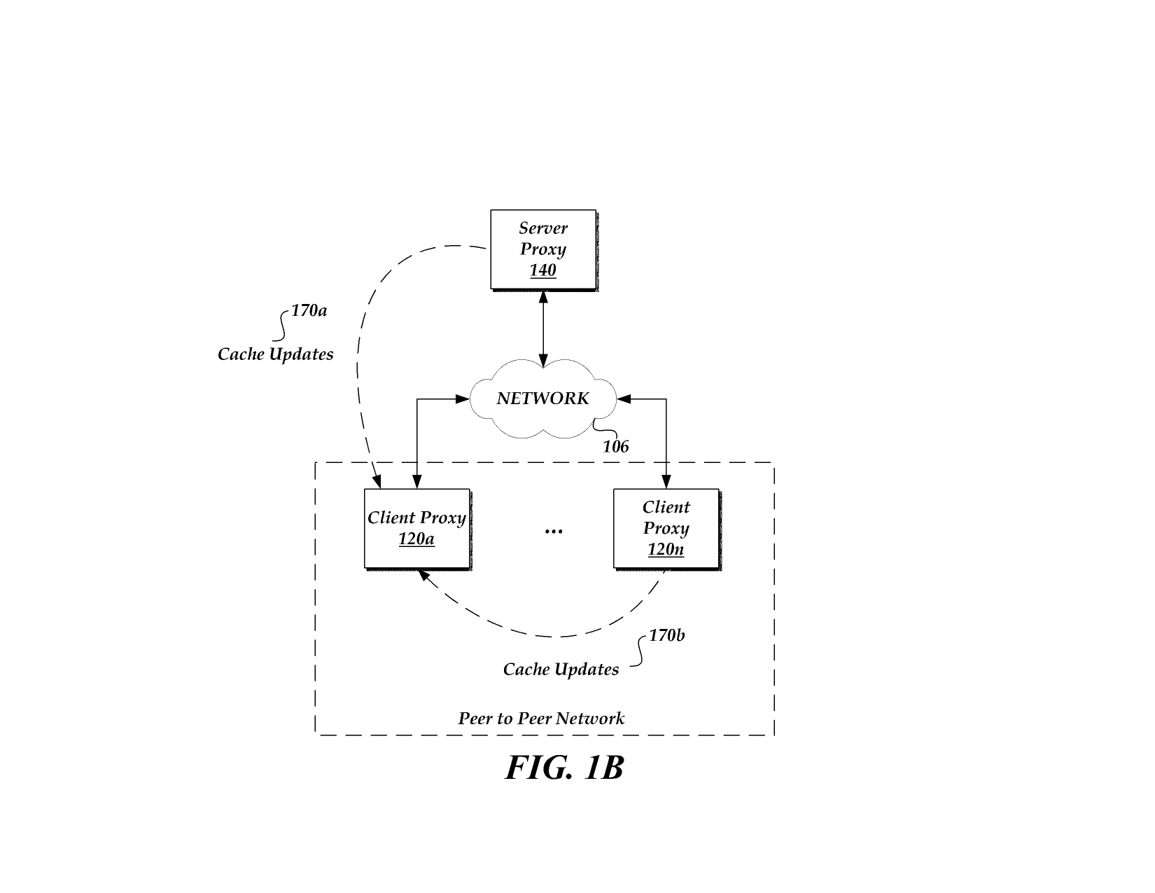

FIG. 1A is a block diagram of a service acceleration system 100 that is configured to accelerate traffic between client computing systems and servers. The service acceleration system 100 can include client systems or user systems 102 and server systems 104 comprising computing hardware, including memory and central processing units (CPUs), and one or more data stores, such as databases and caches. In some embodiments, a server system 104 may be provided by a computing resource provider and may be a virtual server operating on physical hardware. For example, the server system 140 may include computing resources provided by cloud computing service providers. The user systems and/or server systems can include various computing devices, such as, for example, servers, desktops, laptops, smart phones, tablets, and/or other mobile devices. Components of the service acceleration system 100 can be connected via a computer network 106, such as the Internet.

The user systems 102 and server systems 104 can include a data interface for receiving and/or transmitting data over the network 106. The communications link can be via a wired and/or wireless communication link, such as Ethernet, Bluetooth, 802.11a/b/g/n, infrared, universal serial bus (USB), IEEE 1394 interface, or the like. The network 106 can include local area networks (LANs), wide area networks (WANs), the Internet, or a combination of the above. A user system 102 can include a web service interface 110, such as a client application or other software (e.g., web browser, mobile app, widget, gadget, application, etc.), and a client proxy 120. The web service interface 110 and the client proxy 120 may be on the same computing devices or on different computing devices. For example, the functionality of the user system 102 may be provided by two or more computing devices. A server system 104 can include a web service server 130, such as a web server, and a server proxy 140. The web service server 130 can provide one or more web services, such as a vehicle inspection reporting service, sales management service, customer relations management service, inventorying service, or other application. The web service server 130 and the server proxy 140 may be on the same computing devices or on different computing devices. For example, the server proxy 140 may be a stand-alone computing device located on the same or a nearby network to the web service server 130.

In an example scenario involving vehicle inspection reporting, a repair facility customer obtains an inspection of his vehicle from a repair facility. A technician inspects the vehicle and notes any items needing repair and/or further inspection. The technician provides the inspection data in a report to the customer via a web service. The customer can then connect with the web service to obtain the report and/or other data about the inspection. The service acceleration system 100 can accelerate responses from the server system 104 and the user system 102 by reducing the amount of traffic used to communicate content between the systems.

While the above scenario involves an inspection report for vehicles, the service acceleration system 100 is not limited to the particular web service described above and may be applied to any other web service where acceleration of web services is desired. The following description describes an embodiment of the data flow for an accelerated response between the user system 102 and the server system 104 in greater detail. Not all response/request transactions are necessarily accelerated. For example, some requests may involve content not already cached. Those requests may be sent to the web service server 130 without being accelerated.

Beginning at event 1, a user (e.g., the repair facility customer) on the user system 102 requests content (e.g., an inspection report) from the server system 104. In one embodiment, the user utilizes a web service interface 110 on the user system 102 to communicate with a web service server 130 on the server system 104. The web service interface 110 can send a Hypertext Transfer Protocol (HTTP) or request (e.g., an HTTP GET) to the web service server 130 via the client proxy 120.

At event 2, the client proxy 120 receives the HTTP request. The client proxy can include a client cache 150 that stores data for web service. In one embodiment, the client cache stores HTTP requests and hashes associated with the HTTP requests. The client cache 150 can also store responses (e.g., content data) and response hashes.

The hash can be generated by a hash function, such as an algorithm that maps large data sets to smaller data sets. The smaller data sets returned by a hash function may be called hash values, hash codes, hash sums, checksums or hashes. Some hash functions are referentially transparent, where calling the hash function on equal inputs or the same input results in the same output. Some hash functions may map multiple inputs to different results, generating collisions. However some hash functions (e.g., perfect hash functions) can map distinct elements to distinct results, with no collisions. In one embodiment, the hash function is an MD5 hash function, but other hash types of hash functions can be used (e.g., SHA-1, SH2, etc.). In one embodiment, the request or client hash is generated using 1) a URL for the HTTP request, which can include parameter values, 2) an HTTP Post body, or a combination of the above. In one embodiment, the response or server hash is generated based on the body of the server response.

In one embodiment, the client proxy 120 applies the hash function to the HTTP request to generate a request hash. The client proxy 120 then checks the request hash against the client cache to determine if the request is in the cache. For example, referring to FIG. 1, the hash function is applied to the HTTP request and generates a request hash of “RQH1.” RQH1 is in the client cache 150 and is associated with request RQ1. If the request is not found, then the HTTP request and request hash can be stored in the client cache for use in processing future messages.

In one embodiment, entries in the client cache 150 are also contained in a server cache 160. For example, the same requests and response may have been already sent on the network previously, thus, copies of the requests and responses may already be stored on the client and server caches. In one embodiment, the service acceleration system 100 ensures that any entries in the client cache 150 are contained in the server cache 160.

In the illustrated embodiment, a server cache entry includes a request hash, a response hash and/or a response. Other entries can also be included, such as, for example, a client proxy identifier for differentiating entries for different client proxies. In some embodiments, the server cache entry data described above may be split over multiple entries. In the illustrated embodiment, a client cache entry includes a request hash, a request, a response hash and/or a response. In some embodiments, the client cache entry data described above may be split into multiple entries.

In one embodiment, the service acceleration system 100 uses the caches 150, 160 to communicate content between the user system 102 and server system 104 without sending the entire content between the systems. Instead, the service acceleration system 100 sends hashes between the client proxy and server proxy, which then convert those hashes into associated requests and/or responses.

The client proxy 120 and server proxy 140 can also include data storage for log data, such as a log file or log database. The log data can include a copy of the traffic being sent over the network and the actions taken by the client and server proxy. This log data can be used to troubleshoot problems or make improvements to the service acceleration system 100. For example, the log data can be used to “replay” real web traffic, which can be used for testing web services or the service acceleration system 100.

At event 3, the client proxy 120 transmits the request hash (in this example, “RQH1”) to the server system 104. In one embodiment, the response hash is transmitted as the payload of one or more data packets of a networking protocol, such as IP, TCP, or UDP.

In one embodiment, the request hash is transmitted instead of the full request. By transmitting the hashes, the amount of traffic can be reduced. For example, a request that would require ten packets (or other numbers of packets) to transmit could be transmitted using a single packet with the request hash. This can improve the speed of the web service because less data is transferred. In addition, sending fewer packets reduces the chance that one or more packets in the full request are delayed or lost.

In some situations, the full request may be transmitted instead of the hash. For example, in some embodiments, if the request is new, then the server would not have the request previously stored in its cache and would not be able to translate the hash back to the full request.

### Request Reduction Module

At event 4, the server proxy 140 receives the hash request. The server proxy 140 can use the hash to lookup an associated response in the server cache 160. If the response is in the cache, then the server proxy 140 can respond to the hash request with a hash response. For example, in the illustrated server cache 160, “RQH1” is associated with response hash “RSH1,” and the server proxy 140 sends back the response hash “RSH1.”

In one embodiment, the server proxy 140 includes a request reduction module. The request reduction module can reduce different requests to a common request having the same response. By reducing the requests, more matches for requests can be found in the server cache. For example, in FIG. 1A, RQH1, RQH2, and RQH3 reduce to the same response, “Content1.” Thus, “Content1” has a greater hit rate since that response is responsive to multiple requests. Reduction rules can eliminate unnecessary and superfluous differences between requests, allowing what would normally result in two different hashes become a single, shared hash. This can enable efficient cache usage across two or more different requestors.

Reducing a request can include determining whether the request can be mapped to a similar request or otherwise simplified to find a matching request. For example, the request can be an HTTP request having several parameters (e.g., URL parameters). The server proxy 140 can throw out any parameters that would not change the response in order to reduce the HTTP request to a simpler form. The server proxy 140 can then find a response corresponding to the reduced HTTP request.

Reducing the WS request can allow the server proxy 140 to share the same cached HTTP response across multiple similar requests. Reduction can reduce or eliminate redundancy due to non-unique requests by allowing similar requests to reuse the same cache entries. In one embodiment, reduction behavior is defined by reduction rules, which can be a set of rules defined for the server proxy 140. In one embodiment, the reduction rules are defined by an XML file accessible by the server proxy.

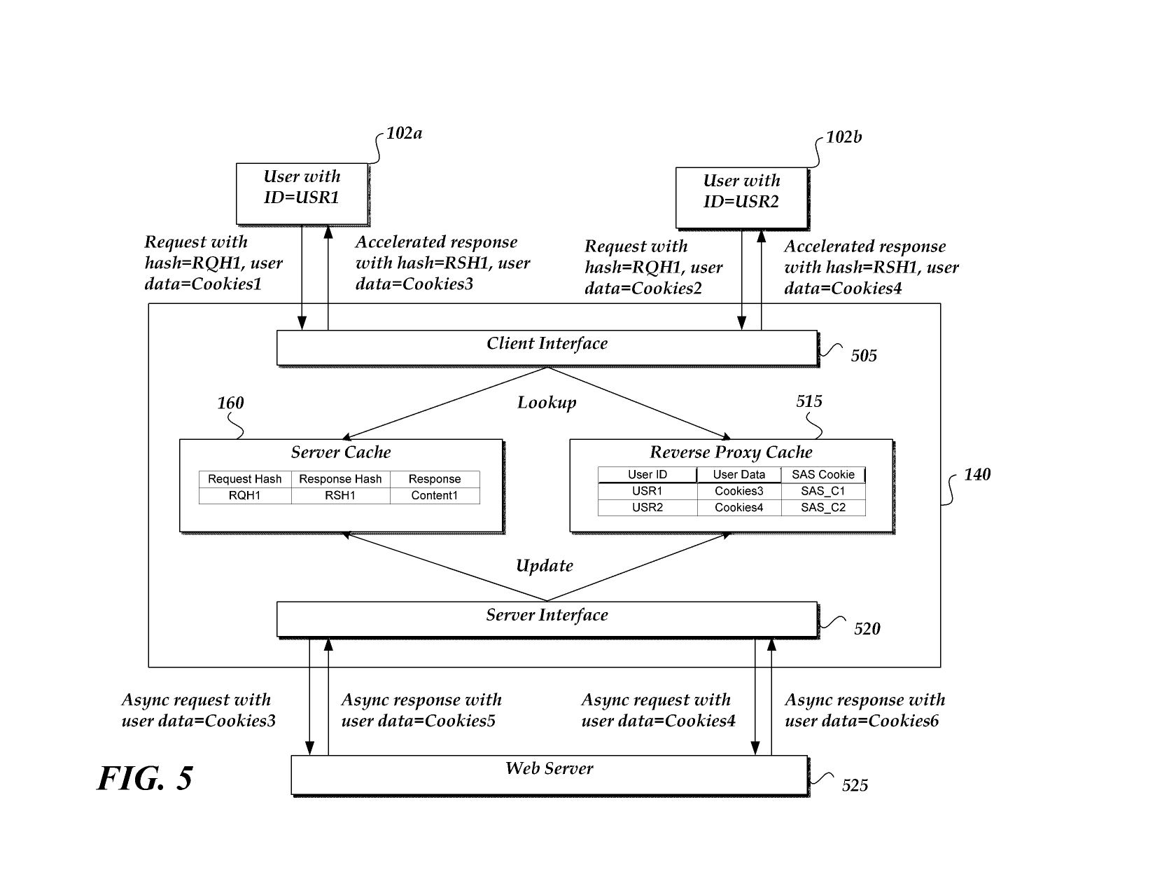

In one embodiment, the server proxy 140 and client proxy 120 together function as a reverse proxy and retrieve resources on behalf of a user system from one or more web services and/or web pages. The reverse proxy can apply the same caching techniques for web pages that it does for web services even though the response may be dramatically different. The reverse proxy functionality is described in further detail with respect to FIG. 5, below. This can include support for cookies and other headers required for web page caching that may not be required for web services. In one embodiment, these headers are separated from the rest of the web content, never reduced and kept current while the content may be reduced and reused even when “stale”. In this embodiment, the bifurcation of headers and content can trick the browser into accepting cached content. In one embodiment, client proxy 120 functions as a proxy server.

At event 5, the server proxy 140 transmits the response hash (e.g., RSH1) to the web service interface. In one embodiment, the response hash is transmitted as the payload of one or more data packets of a networking protocol, such as IP, TCP, or UDP. The data packet can indicate that the response hash is responsive to the request hash, for example, in its header information.

In some situations, the server proxy 140 can respond on behalf of the web services server without requesting data from the web services server. For example, when the response content is in the server cache, the server proxy 140 can respond to the request as it already has the response. In some embodiments, the server proxy 140 can respond on behalf of multiple web services and/or web services servers 130. For example, the server proxy 140 can provide acceleration services for several different web services. The server proxy 140 can cache requests and responses for those web services and respond on behalf of those different web services.

By responding to the request, the server proxy 140 can accelerate the responsiveness of the web service. In some situations, the server proxy 140 can provide load balancing for the web service by responding to the requests on behalf of the web service server 130, thereby reducing the load on the web service server 130. In some situations, the server proxy 140 can reduce the data being transmitted by responding to the request with a hash response. In some embodiments, the server proxy 140 may be closer on the network to the user system and by responding, reduces the distance the responses and/or requests between the user system and the web service have to travel.

At event 6, the client proxy 120 receives the request hash. The client proxy can search the cache to find the request hash (e.g., RSH1) and the associated content (e.g., Content1). The client proxy 120 then prepares an HTTP response for the web services interface 110 having the content responsive to the HTTP request sent at event 1. Typically, an HTTP response includes header information that identifies which request the HTTP response is responsive to. In one embodiment, the client proxy 120 modifies the header information, if needed, to indicate that the HTTP response is responsive to the original HTTP request sent by the web service interface 110.

At event 7, the client proxy 120 sends the HTTP response to the web service interface 110. The web service interface 110 can then provide the content in the HTTP response to the user.

### Asynchronous Cache Updates

At event 8, the server proxy 140 can asynchronously and/or periodically request and receive response updates from the web service server 130. For example, the server proxy 140 may request updates periodically (e.g., every minute, 10 minutes, hour, or other time period). In another example, the server proxy 140 may request updates after it receives requests above a particular threshold. By requesting updates, the server proxy 140 can keep its cache up to date. By requesting updates asynchronously to request responses, the server proxy 140 can respond to content requests without necessarily waiting to receive a cache update, which can increase responsiveness by, for example, shortening the data path for requests and responses. For example, in some situations the following time can be eliminated in responding to a request: 1) data packet travel time from the server proxy 140 to the web service server 130, 2) data packet processing time at the web service 130 (e.g., analyzing a request, finding responsive content, creating a response packet, etc.), and/or 3) data packet travel time from the web service server 130 to the server proxy 4.

### Asynchronous Cache Updates—Predictive Cache Updates

In some embodiments, the server proxy 140 may receive multiple, identical calls from clients (e.g., the client is polling the web service) and the server proxy 140 can reduce the load on the web service by reducing the multiple calls to a single call. For example, a client application can be configured to auto-refresh or seek periodic updates from a web service server 130. This can generate a large number of requests to the web service server 130. In one embodiment, the server proxy 140 can be configured to reduce those requests to fewer requests or even just a single request.

In some embodiments, such as when data “freshness” is very important, the server proxy 140 mimics the polling behavior of its clients and sends polling requests to the server proxy 140 at the same or similar frequency. By polling the web service server 130, the server proxy 140 can provide responses that are about as up to date as the client would receive if it were directly polling the web service server 130. In effect, the server proxy 140 can predictively update its cache in anticipation of poling requests. In addition, the server proxy 140 can perform this polling asynchronously, so the server proxy 140 can still respond to the client requests without necessarily sending the requests to the web service proxy 140. Further, in situations, where multiple clients are polling for the same content, the server proxy 140 can reduce those multiple polling sequences to a single polling sequence. In some embodiments, the server proxy 140 can use more frequent polling (e.g., to keep data “fresher”) or less frequent polling (e.g., to reduce load) in comparison to the polling requests it receives from clients.

### Asynchronous Cache Updates—Call Reduction Rules

In some embodiments, the server proxy 140 may be provided with call reduction rules that manage how the server proxy 140 requests updates from the web service server 130. For example, a “freshness” rule could require that the server proxy always pass on request messages to the web service server 130 in order to ensure that data provided in response to the request message is up to date. In another example, a “read-only” rule could require that the server proxy not request updates to a stored response from the web service server 130 until a specified period of time passes since the server proxy first cached the response. In another example, a “skip N” rule could require that the server proxy not request updates to a stored response until “N” number of requests for the response have been received by the server proxy. In another example, a “timer” rule could require the server proxy to not request updates to a stored response until a certain amount of time has passed. In some embodiments, these rules may be applied per server proxy 140, per web service, and/or per client. In one embodiment, multiple rules may be applied to a proxy server. In one embodiment, no rules may be applied to a proxy server 140.

In some embodiments, the server cache may at times be out of date with the web service server 130. For example, the web service server 130 may have new content added which may not be propagated to the server cache until the server proxy's next request. In one embodiment, the web service server 130 can notify the server proxy 140 of new content. However, in other embodiments, the server proxy 140 does not send notifications to the server proxy 140.

### Example Embodiments

Other variations to the service acceleration system 100 are possible. For example, in one embodiment, instead of a hash function, other types of mapping algorithms are used. In one example, response and/or requests are mapped to an index (e.g., an incremental index, a database index, or index into another data structure). The mapping data can be shared between the client system and the server system or otherwise kept consistent. In one embodiment, the service acceleration system 100 encrypts (e.g., using Advanced Encryption Standard, SSL, public/private key technology, or other encryption technology) and/or compresses (e.g., using Deflate algorithm or other compression technology) at least some data transmitted over the network. In one embodiment, the service acceleration system 100 includes encryption and compression modules and corresponding decryption and decompression modules.

In some embodiments, the service acceleration system 100 is in communication with fewer or more devices than are illustrated in FIG. 1A or 1B. In one embodiment, certain functionalities described herein with respect to the server proxy 140 or client proxy are performed, partly or completely, by other devices, such as a logging system or caching system.

In the embodiment of FIG. 1, the service acceleration system 100 includes any combination of software, firmware, and hardware. For example, the service acceleration system 100 may include only software code that may be executed by suitable computing devices (e.g., a computer or server). Alternatively, the service acceleration system 100 may include a computing device, such as a computing device having one or more central processing units (“CPU”), which may each include conventional microprocessors or any other processing unit. In this embodiment, the service acceleration system 100 further includes one or more memory devices, such as random access memory (“RAM”) for temporary storage of information and/or a read only memory (“ROM”) for permanent storage of information, and one or more mass storage devices, such as hard drives, diskettes, or optical media storage devices. In one embodiment, the components of the service acceleration system 100 are in communication via a standards based bus system, such as bus systems using Peripheral Component Interconnect (PCI), Microchannel, SCSI, Industrial Standard Architecture (ISA) and Extended ISA (EISA) architectures and others. In certain embodiments, components of the service acceleration system 100 communicate via one or more networks, such as a local area network that may be secured.

In general, the term “module,” as used herein, refers to logic embodied in hardware or firmware, or to a collection of software instructions, possibly having entry and exit points, written in a programming language, such as C, C# or C++. A software module may be compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

In one embodiment, the service acceleration system 100 comprises a server based system. In other embodiments, the service acceleration system 100 may comprise any other computing device, such as a computing device or server that is IBM, Macintosh, or Linux/Unix compatible. In another embodiment, the service acceleration system 100 comprises a desktop personal computer (PC), a laptop computer, a cellular phone, personal digital assistant (PDA), or a kiosk, for example.

The service acceleration system 100 is generally controlled and coordinated by operating system software, such as server based software. In other embodiments, the service acceleration system 100 comprises modules that execute one or more other operating systems, such as Android, Chrome, iOS, Windows 95, Windows 98, Windows NT, Windows 2000, Windows XP, Windows Vista, Windows 7, Windows Server, Linux, SunOS, Solaris, PalmOS, Blackberry OS, or other mobile, desktop or server operating systems. In Macintosh systems, the operating system may be any available operating system, such as MAC OS X. In other embodiments, the service acceleration system 100 may be controlled by a proprietary operating system. Conventional operating systems control and schedule computer processes for execution, perform memory management, provide file system, networking, and I/O services, and provide a user interface, such as a graphical user interface (“GUI”), among other things.

The service acceleration system 100 can include one or more commonly available input/output (I/O) devices and interfaces (not shown), such as a keyboard, mouse, touchpad, speaker, and printer. In one embodiment, the I/O devices and interfaces include one or more display device, such as a monitor, that allows the visual presentation of data to a user. More particularly, a display device provides for the presentation of GUIs, application software data, and multimedia presentations, for example. The service acceleration system 100 may also include one or more multimedia devices, such as speakers, video cards, graphics accelerators, and microphones, for example.

### Peer-to-Peer Caching

FIG. 1B is a block diagram illustrating an embodiment of cache updating in the service acceleration system 100 of FIG. 1A. In the illustrated embodiment, the server proxy 140 is in communication with client proxies 120a-102n. In one embodiment, cache updates are received by the client proxy 120a from the server proxy 140 and/or from other client proxies (e.g., client proxies 120b-120n). However, in other embodiments, cache updates may be received by the client proxy 120a only from the server proxy 140 or only from other client proxies 120n.

In some situations, cache updates 170a are received from the server proxy 140. For example, when the client proxy 120a receives a full response from the server proxy 140, the client proxy 120a can store that response in its cache, along with an associated response hash.

In some situations, cache updates 170b are received from other client proxies 120n. In some embodiments, the client proxies form a peer-to-peer network and communicate data between each other. In one embodiment, the client proxies share cache updates between each other. For example, if one client proxy 120n receives a cache update from the server proxy 140 in response to an HTTP request, the client proxy 120n can send that cache update to all or some of the other client proxies 120a. By sharing responses, client proxies can have more responses stored in the cache, increasing the hit rate of requests and responses.

In some embodiments, the client proxy 120a sends a cache content update to the server proxy 140 to inform the server proxy 140 of the new content in its cache. In some embodiments, the client proxy 120a can send the server proxy 140 a list of all its hashes or just some of its hashes (e.g., for the new content.) By sending cache content updates, consistency can be maintained between the server cache and the client cache.

### Example Methods

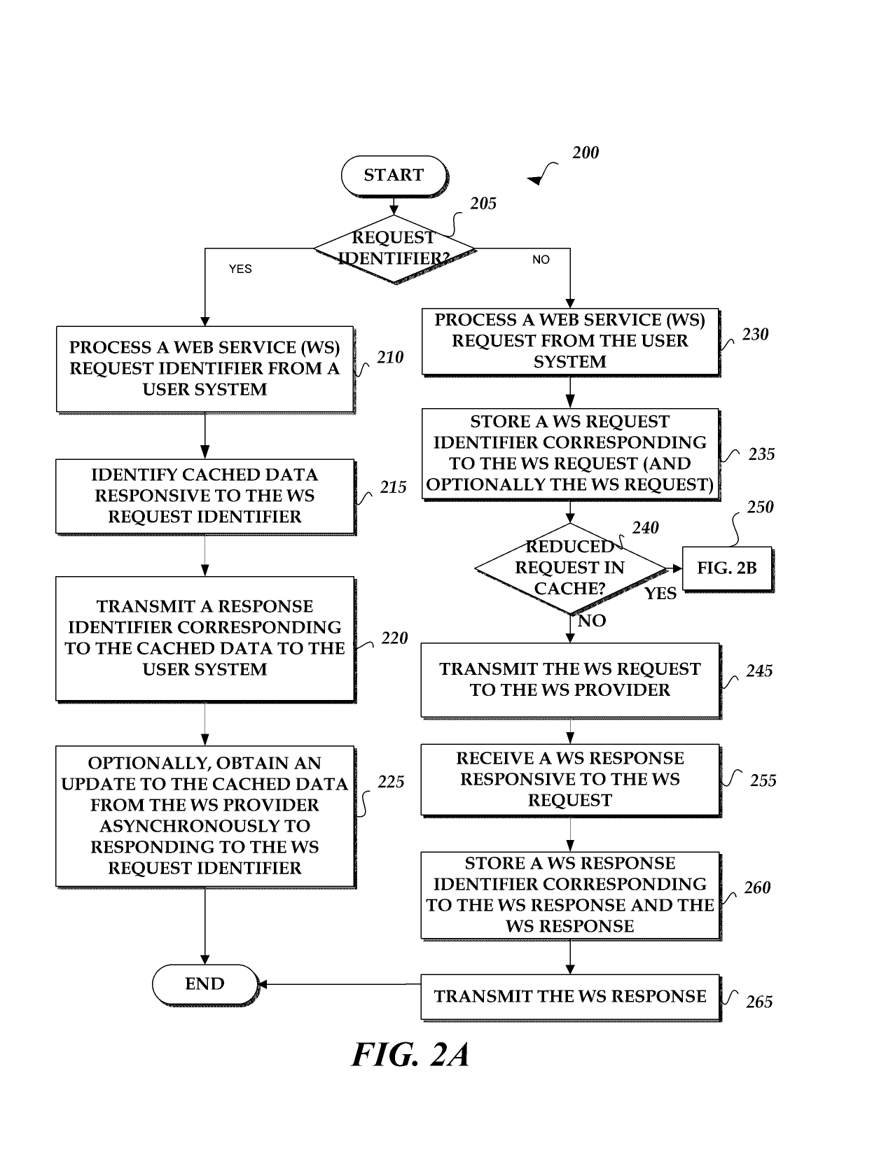

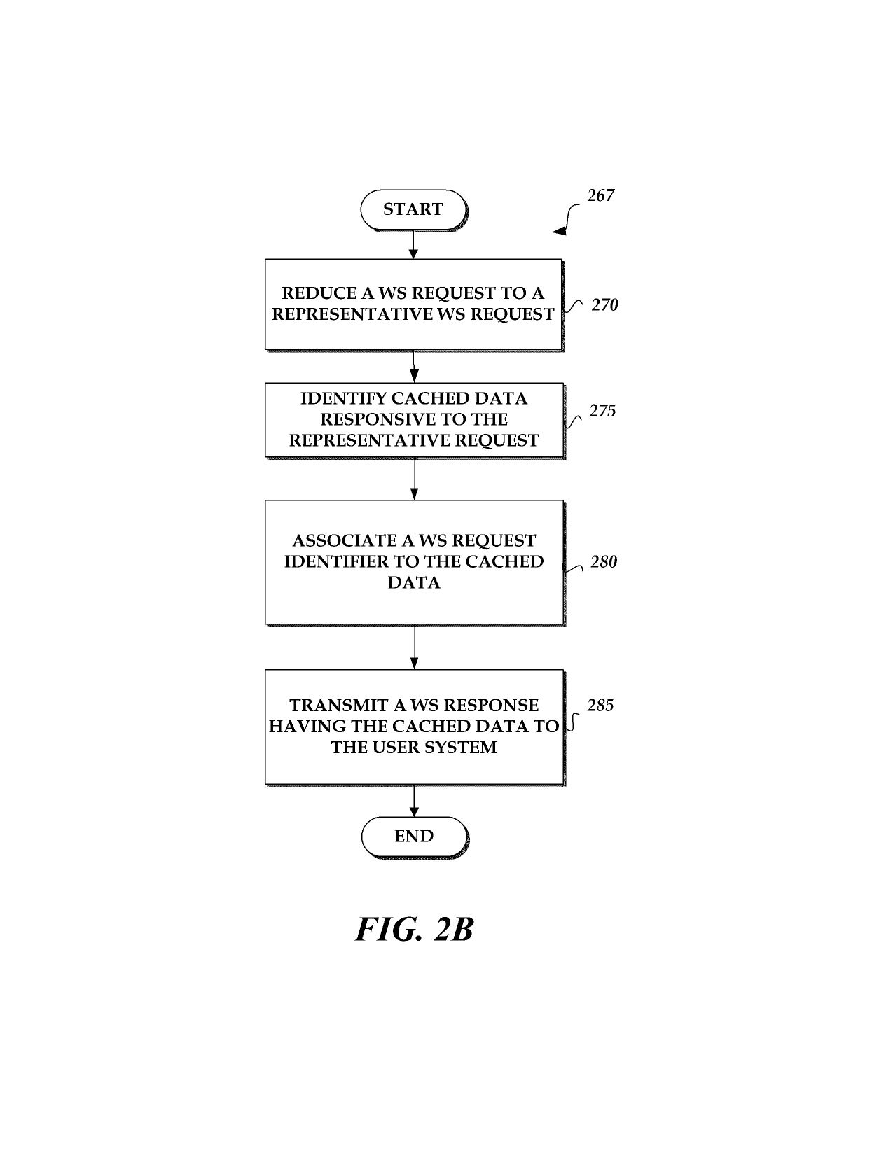

FIG. 2A illustrates a flowchart of an embodiment of a process 200 for responding to a web service request. The process can be used, for example, by the service acceleration system 100 or other portions of the systems illustrated in FIG. 1A, such as the server proxy 140 of FIG. 1A. Depending on the embodiment, the process of FIG. 2A may include fewer or additional blocks and/or the blocks may be performed in a different order than is illustrated. Software code configured for execution on a computing device in order to perform the process of FIG. 2A may be provided on a computer readable medium, such as a compact disc, digital video disc, flash drive, or any other tangible medium. Such software code may be stored, partially or fully, on a memory device of the computing device, such as the service acceleration system 100, in order to perform the process outlined in FIG. 2A by those respective devices. For ease of explanation, the method will be described herein as performed by the server proxy 140; however, the method may be performed wholly or partially by any other suitable computing device or system.

Beginning at block 205, the server proxy 140 receives, over a network, a communication from a user system (e.g., user system 102 of FIG. 1A) directed to a web service (WS) provider. The server proxy 140 determines if the communication includes a WS request identifier or a WS request. If the communication includes a WS request identifier (e.g., the response/request has previously been sent over the network) or the WS request identifier is found in the server proxy's cache, the server proxy 140 proceeds to block 210.

At block 210, the service acceleration system 100 processes the WS request identifier from a user system. For example, the WS request can be a request for a vehicle inspection report or a portion of the report, such as repair or inspection information for a vehicle. In one embodiment, the WS request identifier is a hash corresponding to a WS request.

In some embodiments, the service acceleration system 100 can reduce the request identifier to find a response. In one embodiment, the server cache 160 of FIG. 1A can store the full request in addition to the request identifier. When the request identifier is received, the server proxy 140 of FIG. 1A can obtain the full request from the cache and use the request reduction module to reduce the full request in order to find an existing response on the server cache 160. In one embodiment, the server proxy 140 can then associate the request identifier with the found response. The service acceleration system 100 can then just lookup the response in the server cache 160 for subsequent instances of the request identifier.

At block 215, the server proxy 140 identifies cached data responsive to the WS request identifier. For example, the server proxy 140 can lookup the WS request identifier in its cache and identify the response corresponding to the WS request identifier.

In some situations, the server proxy 140 may not be able to find cached data responsive to the WS request identifier. In one embodiment, the server proxy 140 may request that the user system provide the full WS request message corresponding to the WS request identifier. The server proxy could then process the full request message according to block 230 and subsequent blocks.

At block 220 the server proxy 140 transmits a response identifier corresponding to the cached data to the user system. The user system (or a client proxy 120) can then determine the response based on the response identifier, for example, by performing a lookup in its cache.

At block 225, the server proxy 140 can optionally obtain an update to the cached data from the WS provider asynchronously to responding to the WS request identifier. In some embodiments, the server proxy can request the update periodically or at some future time. The process 200 can then end.

Returning to block 205, if the communication includes a WS request (e.g., the response/request message has not previously been sent over the network) and/or if the request identifier cannot be found in the cache, the server proxy 140 proceeds to block 230.

At block 230, the server proxy 140 processes the WS request from the user system.

At block 235, the server proxy 140 stores a WS request identifier corresponding to the WS request. The server proxy can also optionally store the WS request. In one embodiment, the server proxy 140 generates the WS request by applying a hash function to the WS request.

At block 240, the server proxy 140 determines whether the WS request is reducible and/or whether the reduced request is in the cache. Reducing the WS request can include determining whether the WS request can be mapped to a similar request or otherwise simplified to find a matching request. For example, the WS request can be an HTTP request having several parameters (e.g., URL parameters). The server proxy 140 can throw out any parameters that would not change the response in order to reduce the HTTP request to a simpler form. The server proxy 140 can then find a response corresponding to the reduced HTTP request.

If the WS request is not reducible, the server proxy 140 proceeds to block 245. If the WS request is reducible, the server proxy 140 proceeds to block 250 and performs the process 267 illustrated in FIG. 2B.

At block 245, the server proxy 140 transmits the WS request to the WS provider. In one embodiment, the WS provider is the web service server 130 of FIG. 1A.

At block 255, the server proxy 140 receives a WS response responsive to the WS request.

At block 260, the server proxy 140 stores a WS response identifier corresponding to the WS response and the WS response. In one embodiment, the server proxy applies a hash function to the WS response to generate the WS response identifier. In future response/request transactions, the service acceleration system 100 can use the WS response identifier to refer to the response rather than sending the response to the user system.

At block 265, the server proxy 140 transmits the WS response to the user system. In one embodiment, the response is streamed to the user using a streaming protocol, where small chunks of data (e.g., packet size) are compressed, encrypted and/or transmitted individually. In one embodiment, the entire response may be compressed and/or encrypted and then transmitted. The user system can then decompress and/or decrypt the response as needed and provide the response to a user. The process 200 can then end.

FIG. 2B illustrates a flowchart of an embodiment of a process 267 for reducing a web service (WS) request. The process 267 can be used, for example, by the service acceleration system 100 or other portions of the systems illustrated in FIG. 1A, such as the server proxy 140 of FIG. 1A. Depending on the embodiment, the process of FIG. 2B may include fewer or additional blocks and/or the blocks may be performed in a different order than is illustrated. Software code configured for execution on a computing device in order to perform the process of FIG. 2B may be provided on a computer readable medium, such as a compact disc, digital video disc, flash drive, or any other tangible medium. Such software code may be stored, partially or fully, on a memory device of the computing device, such as the service acceleration system 100, in order to perform the process outlined in FIG. 2B by those respective devices. For ease of explanation, the method will be described herein as performed by the server proxy 140; however, the method may be performed wholly or partially by any other suitable computing device or system.

Beginning at block 270, the server proxy 140 reduces a WS request to a representative WS request. As discussed above, reducing the WS request allow the server proxy 140 to share the same cached HTTP response across multiple similar requests.

At block 275, the server proxy 140 identifies cached data responsive to the representative request. In one embodiment, the server proxy 140 applies a hash function to the representative request to generate a hash and then searches its cache using the hash.

At block 280, the server proxy 140 associates a request identifier to the cached data. In one embodiment, the request identifier is generated by applying the hash function to the WS request. By associating the request identifier to the cached data, the server proxy 140, for future transactions, can identify cached data responsive to the WS request by performing a cache lookup without necessarily having to reduce the WS request to a representative request. However, in other embodiments, the server proxy 140 does not associate the request identifier to the cached data to enable this optimization.

At block 285, the server proxy 140 transmits a WS response having the cached data to the user system. In some embodiments, the server proxy can include the response identifier with the response so that the user system (e.g., the client proxy 120) can store the response identifier without separately calculating it. However, in other embodiments, the server proxy does not include the response identifier and the user system applies the same hash function used by the server proxy 140 to the response to generate the corresponding WS response identifier. The process 267 can then end.

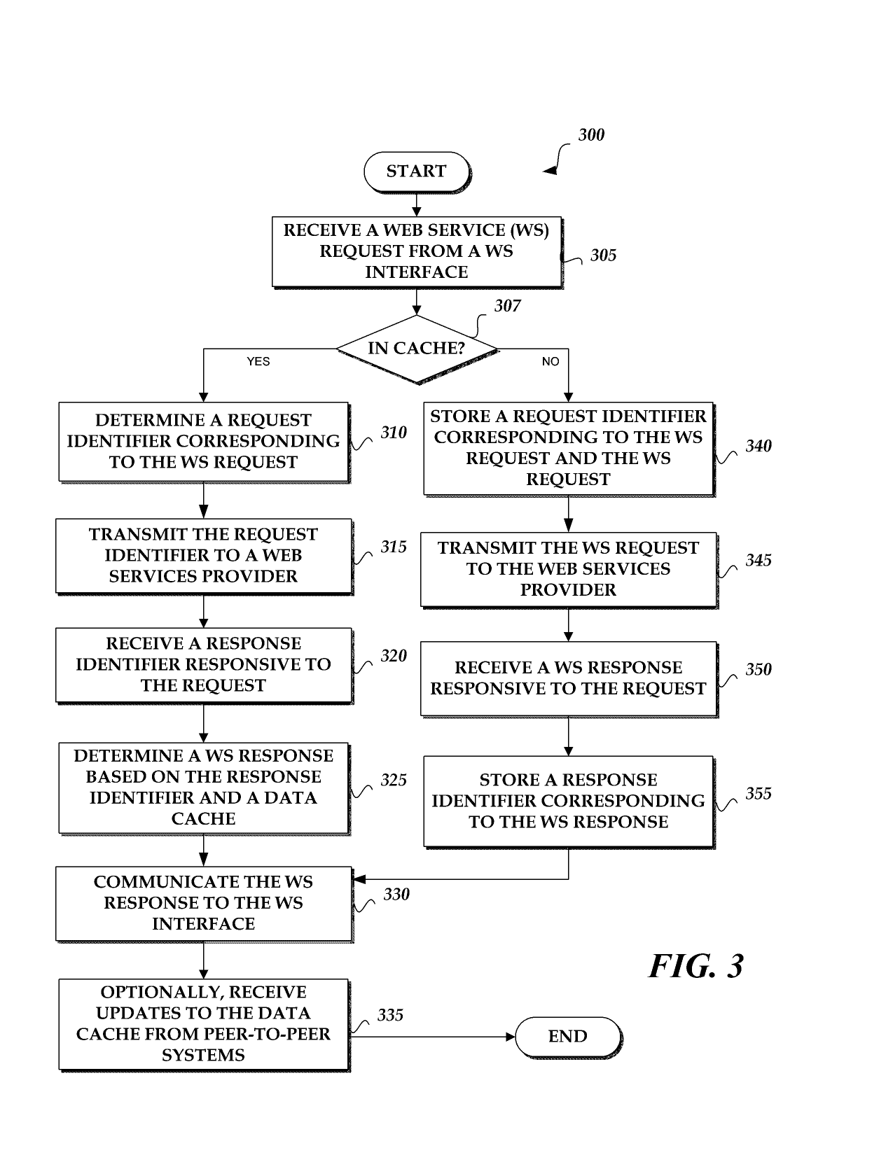

FIG. 3 illustrates a flowchart of an embodiment of a process 300 for requesting a web service response. The process can be used, for example, by the service acceleration system 100 or other portions of the systems illustrated in FIG. 1A, such as the client proxy 120 of FIG. 1A. Depending on the embodiment, the process of FIG. 3 may include fewer or additional blocks and/or the blocks may be performed in a different order than is illustrated. Software code configured for execution on a computing device in order to perform the process of FIG. 3 may be provided on a computer readable medium, such as a compact disc, digital video disc, flash drive, or any other tangible medium. Such software code may be stored, partially or fully, on a memory device of the computing device, such as the service acceleration system 100, in order to perform the process outlined in FIG. 3 by those respective devices. For ease of explanation, the method will be described herein as performed by the client proxy 120; however, the method may be performed wholly or partially by any other suitable computing device or system.

Beginning at block 305, the client proxy 120 receives a web service (WS) request from a WS interface (e.g., the WS interface 110 of FIG. 1A). In one embodiment, the web service request can be an HTTP request.

At block 307, the client proxy 120 determines if the WS request is stored in the cache. In one embodiment, the client proxy 120 applies a hash function to the WS request to generate a hash and looks up the hash in its cache. In another embodiment, the client proxy 120 searches the cache using the WS request itself. If the WS request is stored in the cache, the client proxy proceeds to block 310.

At block 310, the client proxy 120 determines a request identifier corresponding to the WS request. In one embodiment, the request identifier is the hash generated as described in block 307. In one embodiment, the WS request is associated with the request identifier in the cache and the client proxy 120 gets the request identifier from the cache.

At block 315, the client proxy 120 transmits the request identifier to a web services provider (e.g., the web services server 130 of FIG. 1A) via the server proxy (e.g., the server proxy 140 of FIG. 1A). Typically, the request identifier is transmitted using one or more packets having a network address (e.g., IP address) corresponding to the web services provider or the server proxy. In one embodiment, the request identifier is received by the server proxy on behalf of the web services provider.

At block 320, the client proxy 120 receives a response identifier responsive to the request. In one embodiment, the response identifier is sent by the server proxy on behalf of the web services provider.

At block 325, the client proxy 120 determines a WS response based on the response identifier and its data cache. In one embodiment, the client proxy 120 looks up the WS response in its cache using the response identifier.

At block 330, the client proxy 120 communicates the WS response to the WS interface. The WS response can be transmitted over a network (e.g., if the WS interface is on a different computing device) or within a computing device (e.g., if the WS interface is on the same computing device as the client proxy 120).

At block 335, the client proxy 120 optionally receives updates to its data cache from peer-to-peer systems, as described in FIG. 2A.

Going back to block 307, if the WS request is not stored in the cache, the client proxy proceeds to block 340.

At block 340, the client proxy 120 stores a request identifier corresponding to the WS request, as well as the WS request. Typically, this happens when the request/response is new or otherwise not previously stored in the client proxy cache. In one embodiment, the client proxy 340 applies a hash function to the WS request in order to generate the request identifier.

At block 345, the client proxy 120 transmits the WS request to the web services provider. Typically, the WS request is transmitted using one or more packets having a network address (e.g., IP address) corresponding to the web services provider or the server proxy. In one embodiment, the WS request is received by the server proxy on behalf of the web services provider.

At block 350, the client proxy 120 receives a WS response responsive to the request. In one embodiment, the WS response is sent by the server proxy. The server proxy can obtain the WS response from its cache or from the web services provider. In one embodiment, the WS response is encrypted and/or compressed and the client proxy 120 decrypts and/or decompresses the WS response.

At block 355, the client proxy 120 stores a response identifier in its cache corresponding to the WS response. In one embodiment, the client proxy 120 generates the response identifier by applying a hash function on the WS response. The response identifier can be used in future responses as described in block 310 and subsequent blocks. The client proxy 120 then proceeds to block 330 and performs the functions described above with respect to block 330 and subsequent blocks until the process 300 ends.

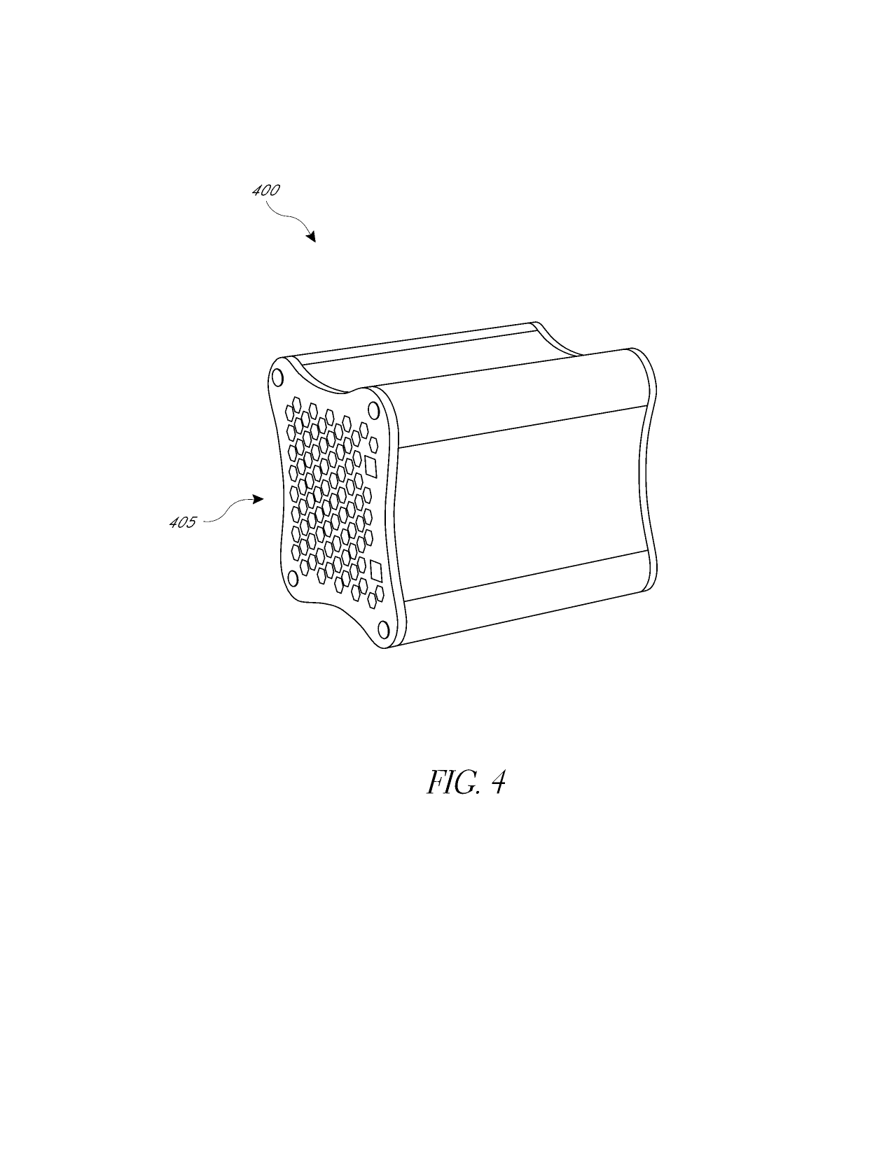

FIG. 4 illustrates an embodiment of an accelerator computing device 400. In some embodiments, the accelerator can include one or more components of the service acceleration system 100 of FIG. 1A. For example, the accelerator device 400 can include the server proxy 140 or the server system 104. In another example, the accelerator device 400 can include the client proxy or the user system 102. The accelerator device 400 can be installed onto an existing network to provide acceleration services. In one embodiment, the accelerator device 400 can be added to a network to act as reverse or secure proxy between web or desktop applications and remote web services.

In one embodiment, the accelerator device 400 includes one or more processors, one or more memory devices (e.g., hard drive, SSD, RAM, etc.) and one or more input/output interfaces. One or more sides 405 of the accelerator computing device 400 can include apertures for providing ventilation for hardware components within the accelerator device 400.

In one embodiment, the accelerator computing device 400 is cubical. Sides of the of the accelerator device 400 can be concave. In the illustrated embodiment, four sides of the accelerator device 400 are concave, with the remaining two opposing sides substantially flat. In one embodiment, the edges of the device are from about four to about eight inches. In some embodiments, the edges are less than four inches, while in other embodiments, the edges are more than four inches. In some embodiments, the accelerator device can be shaped differently.

### Reverse Proxy Caching

FIG. 5 illustrates an embodiment of the service acceleration system 100 that includes reverse proxy functionality. An HTTP request/response generally contains a number of HTTP header fields or “headers” in addition to the starting line and body. For the same content, the starting line and body are frequently the same among different HTTP clients (e.g., web service clients, web browsers) but the headers usually differ. For example, different browsers (e.g., web clients) can have a different set of cookies which in turn can affect the response returned by server (e.g., it may be different for each browser instance). Different users can also have different cookies when they use the same browser but different user accounts. In one embodiment, the service acceleration system 100 “reduces” requests from different web clients even if they have different cookies, which enables caching of a resource or content across different web clients.

A cookie, also known as an HTTP cookie, web cookie, or browser cookie, is used by an origin website to send state information to a user's browser and for the browser to return the state information to the origin website. The state information can be used for authentication, identification of a user session, user's preferences, shopping cart contents, or anything else that can be accomplished through storing data on the user's computer. For example, a session cookie tracks user sessions and generally only lasts for the duration of users using the website. Some session cookies can store unique session identifiers, which can be used to identify the user's session. A web browser typically deletes session cookies when it closes.

Cookies can include arbitrary pieces of data chosen by a web server and sent to a browser. Typically, the browser returns them unchanged to the server, introducing a state, or memory of previous events, into otherwise stateless HTTP transactions. Without cookies, each retrieval of a Web page or component of a Web page is typically an isolated event, mostly unrelated to all other views of the pages of the same site. In addition to being set by a web server, cookies can also be set by a script in a language such as JavaScript, if supported and enabled by the web browser.

In the embodiment of FIG. 5, the service acceleration system 100 includes a server proxy 140 in communication with one or more user systems 102a, 102b and a web server 525 (e.g., the web services server 104 of FIG. 1A). The server proxy 140 includes a client interface 505 for communicating with the user systems 102a, 102b, a server cache 160, a reverse proxy cache 515, and a server interface 520 for communicating the web server 525. In some embodiments, the client and server interfaces 505, 520 are application interfaces or message protocol interfaces (e.g., Simple Object Access Protocol). The reverse proxy cache 515 can store entries for different users. A user entry can include a user identifier and one or more associated cookies.

In one example transaction, the user system 102a sends a request to the server proxy 140. The request can include a hash (e.g., “RQH1”) and user data (e.g., “Cookie1”). The server proxy 140 can determine if a response (e.g., “Content1”) is stored in the server cache 160 using the hash and can send an accelerated response having a response hash (e.g. “RSH1”) as described in the disclosure above.

Meanwhile, in another example transaction, a second user system 102b sends a second request to the server proxy 140. The request can include a hash (e.g., “RQH1”) and user data (e.g., “Cookie2”). Assuming the responses to the requests from the two user systems 102a, 102b are the same except for differing user data, the server proxy 140 can send an accelerated response having the same response hash (e.g. “RSH1”) that was sent to the first user system 102a. This allows the same stored response (e.g., “Content1”) to be used or referenced for different users.

To account for the different user data, the server proxy 140 can track the user data (e.g., cookies) sent between the user systems 102a, 102b and the web server 525 and include the appropriate user data in its responses. The server proxy 140 can then include, generate, or modify headers sent in its responses to the user systems in order to account for the different user data sent to/from the different user systems 102a, 102b. For example, the server proxy 140 can determine a response cookie (e.g., “Cookie3”) to send to the first user system 102a by searching the reverse proxy cache 515 for the appropriate response cookie. Likewise, the server proxy 140 can determine the appropriate response cookie (e.g., “Cookie4”) for the second user system 102b. In one embodiment, the server proxy 140 uses its own cookies (“SAS cookies”) that it sends and receives from the user systems 102a, 102b to identify a particular user system and obtain the user data associated with the particular user system.

After responding to the user requests, the server proxy 140 can then asynchronously update the server cache 160 and/or the reverse proxy cache 515 by sending a request to the web server 525 and receiving a response. For example, the server proxy 140 can send a request having user data (e.g., “Cookie3”) corresponding to the first user system 102a and then receive a response having updated user data (e.g., “Cookie5”) and updated content. The server proxy 140 can then update the server cache 160 with the updated content and can also update the reverse proxy cache 515 with the updated user data. Similarly, the server proxy 140 can send a request having user data (e.g., “Cookie4”) corresponding to the second user system 102b and receive updated user data (e.g., “Cookie6”).

The example scenario below describes sample transactions that illustrate an embodiment of a process by which the service acceleration system 100 provides accelerated reverse proxy functionality. In the example scenario, a target server (e.g. for an Internet forum) uses sessions with a sliding expiration of one hour; after one hour, the target server requires users to login again. Typically the sliding expiration is implemented via cookies. In one implementation, the target server updates a client cookie when it replies to a client request, wherein the target server extends the expiration time (e.g., by one hour) for the client cookie when it sends the reply. In the example scenario, the resource or content being received by the users is the same, but the target server requires user to be logged in and have cookies. Thus, responses from the target server can have different headers based on the receiving user client. The service acceleration system 100 enables the same cached content or resource to be used in responses to different user clients, even if the responses utilize different headers.

During a first transaction, a user client (e.g., “USR1”) sends a request at 4:00 p.m. to the server proxy 140 for the first time, thus the response to the request is not yet cached. In one embodiment, the server proxy 140 analyzes the request and determines if a session cookie exists. Generally, a session cookie exists if the user is already logged in. In this scenario, the user previously logged in and thus a session cookie already exists.

As no response is cached, the server proxy 140 can call the target server synchronously in response to receiving the request. In response, the target server can return a response message with response content and an updated session cookie (e.g. “Cookie3”) that prolongs the expiration time to 5:00 p.m. (due to the target server's one hour sliding expiration sessions). The server proxy 140 can create an entry for this user client in a reverse proxy cache 515 and can store a copy of the reply cookies (e.g. “Cookie3”) in the cache 515. The server proxy 140 can store its own cookie (“SAS cookie”) in addition to the response cookies to indicate that the HTTP client is known to the server proxy 140. In one embodiment, the SAS cookie expires when the reverse proxy cache entry expires. In one embodiment, the domain and path of the SAS cookie are equal to the scope of the session cookie. In one embodiment, the server proxy 140 modifies the original response, for example, by adding the SAS cookie, adding a new “Set-Cookie” HTTP header to the response headers, or otherwise modifying the HTTP header of the response. By modifying the response, the service acceleration system 100, can recognize (e.g., on the server proxy 140 and/or the client proxy) the HTTP client (e.g., USR1) in future transactions, which can affect how the service acceleration system 100 processes packets from the HTTP client. For example, the service acceleration system 100 can use the SAS cookie to determine that an entry is cached for a particular client and/or whether a cached entry is still valid. The server proxy 140 can then return the modified reply to the user client.

During a second transaction, the user client resends the request at 4:20 p.m. In this scenario, the request already contains the updated session cookie and a SAS cookie. The server proxy 140 can use the SAS cookie to identify or recognize the HTTP client. In one embodiment, the server proxy 140 updates the SAS cookie by extending its lifetime (e.g., by one hour) after responding to the request.

The server proxy 140 can send a response message back to the user client with the updated SAS cookie (e.g., “SAS_C1”). The server proxy 140 may then update the server cache 160 asynchronously to the response (e.g., at a time after the cached response is sent). In one embodiment, the updated response contains an updated session cookie (e.g., “Cookie5”) with the expiration prolonged to 5:20 p.m. (one hour later). The server proxy 140 can store the response content (e.g., “Content1”) in the server cache 160 and update the session cookie in the reverse proxy cache 515 for this user client.

During a third transaction, the user client sends the request again at 5:01 p.m. In this scenario, the original session cookie from the web server 525 with an expiration time of 5:00 p.m. has already expired, but the cached session cookie is still valid until 5:20 p.m. Likewise, SAS cookie is still active because it was updated previously to expire at 5:20 p.m. The active SAS cookie indicates to the server proxy 140 that an entry for the user client exists in the reverse proxy cache 515. In one embodiment, the server proxy 140 receives the SAS cookie, determines that an entry exists, and then looks up the cached session cookie from the reverse proxy cache.

The server proxy 140 can then generate a response message to the client request by getting a cached response (e.g., “Content1) from the server cache 160 and adding the cached user cookies to the cached response. The server proxy 140 can also prolong the SAS cookie time and/or the cached session cookie time. In one embodiment, the server proxy 140 replies to the user client with the cached response having the cached session cookie and the SAS cookie.

The server proxy 140 can asynchronously update the server cache 160 by sending the request it received from the user client with the cached session cookie (which expires at 5:20 p.m.) to the web server 525. The server proxy 140 can receive from the web server the response with an updated session cookie, which prolongs the session cookie lifetime to 6:01 p.m. The server proxy 140 can update the reverse proxy cache with the new cookies for this user and can update the server cache 160 with the response contents (e.g., “Content1”).

During a fourth transaction, the user client sends the request again at 6:21 p.m. Logically, the request should result in the user client being forced to login again as the session cookie has expired and, in one embodiment, the server proxy 140 responds this way to the user request.

The server proxy 140 analyzes the request and determines that there is no session cookie (expired at 5:20 p.m.). If the request includes a SAS cookie, indicating that the user is known and may have cached cookies, the server proxy 140 looks up the cached session cookie from the reverse proxy cache 515. In this scenario, the server proxy 140 determines that the cached session cookie from reverse proxy cache is already expired (at 6:01 p.m.). On the other hand, if there is no SAS cookie, then, in this scenario, no reverse proxy cache entry is available for the user. In either case, no cached cookies are available.

If no cached cookies are available, the server proxy 140, in one embodiment, then searches for a corresponding response in the server cache 160. For example, the response can be a cached redirect page or an HTTP ‘403 Forbidden’ reply sent by the web server 525 when previous session cookies expired. If a cached response is found, the server proxy 140 can return the cached response and can then queue an asynchronous update. On the other hand, if no cached response is found, the server proxy 140 can send the request synchronously to the web server 525, receive an original redirect page in a response from the web server, return the original redirect page to the user client, and/or update the server cache 160 with the response. In both cases the user client receives the redirect to the login page.

Various implementations of the service acceleration system are possible. In some embodiments, the request hash is generated using one or more of the request URL, the body, the HTTP headers or potions of the HTTP headers (e.g., “User-Agent,” or “Accept-Language”), and/or cookies. For example, if reverse proxy functionality is disabled then cookies can be included in request hash because they can influence the response hash. In another example, if reverse proxy functionality is enabled the cookies may not be included in the hash but instead are managed by the reverse proxy cache. In some embodiments, the response hash is generated using one or more of the response status code, the response status description, and/or the response body. Other implementations are also possible.

While the service acceleration system 100 has been described in reference to vehicle reporting related web services, it will be apparent that the systems and processes described above can be useful in a variety of situations. For example, the service acceleration system 100 can be used with any type of web service, such as, for example, photo sharing services, Internet commerce services, informational services, web searches, database services as well as other types of client-server network transactions. In addition, while the above describes accelerating HTTP messages, other messages protocols can also be accelerated, such as Hypertext Transfer Protocol Secure (HTTPS), Representational State Transfer (REST), Simple Object Access Protocol (SOAP) and JavaScript Object Notation (JSON).

Depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosure described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system for accelerating messages between a client and a server, the system comprising:
a server data storage comprising a response message, a response identifier associated with the response message and a request identifier, the response message sourced from the server;
a client data storage comprising the response message, the response identifier associated with the response message, the request identifier, and a request message associated with the request identifier, the request message sourced from the client;
a client proxy with access to the client data storage, the client proxy configured to:
receive the request message from the client;
determine the request identifier based on the request message; and
transmit, over a network, the request identifier to a server proxy; and
the server proxy with access to the server data storage, the server proxy in communication with the client proxy, the server proxy configured to:
receive, over the network, the request identifier from the client proxy;
identify the response identifier responsive to the request identifier using the server data storage and the request identifier; and
transmit, over the network, the response identifier associated with the response message to the client proxy;
wherein, in response to receiving the response identifier, the client proxy is configured to obtain the response message associated with the response identifier from the client data storage and communicate the response message to the client.

2. The system of claim 1, wherein the client comprises a client application.

3. The system of claim 1, wherein the server comprises a web services application.

4. The system of claim 3, wherein the request message requests content from the web services application and the response message includes the content.

5. The system of claim 1, wherein the response identifier is generated by applying a mapping algorithm to the response message.

6. The system of claim 5, wherein the mapping algorithm comprises a hash function.

7. The system of claim 6, wherein the response identifier is a hash generated by the hash function.

8. The system of claim 1, wherein the request identifier is generated by applying a mapping algorithm to the request message.

9. The system of claim 1, wherein the request message and response message comprise HTTP messages.

10. The system of claim 1, wherein the response identifier is smaller in data size than the response message.

11. The system of claim 1, wherein the response identifier is transmitted by the server proxy to the client proxy using a single data packet.

12. The system of claim 1, wherein the server proxy is configured to request updates to the response message from the server asynchronously to responding to request identifier from the client proxy.

13. The system of claim 1, wherein the server proxy is configured to request updates to the response message from the server asynchronously to responding to request identifier from the client proxy.

14. The system of claim 1, wherein the server proxy is configured to identify the response identifier responsive to the request identifier by:
determining the request message associated with the request identifier;
determining the response message responsive to the request message; and
determining the request message identifier associated with the request message.

15. A method of accelerating requests between a user system and a server system, the method comprising:
storing a first response message and a first response identifier corresponding to the first response message, the first response message responsive to a first request message, the first response message received during an transaction between the user system and the server system;
receiving a second request message from the user system, the second request message different from the first response message;
determining that the second request message is reducible to the first request message; and
in response to determining that the second request message is reducible, responding to the second request message by communicating the first response identifier to the user system;
wherein the user system is configured to obtain the first response message from a data storage local to the user system by using the first response identifier.

16. The method of claim 15, wherein the user system comprises a client application and the user system provides the first response message to the client application.

17. The method of claim 15, further comprising updating the first response message by requesting an update from the server system asynchronously to responding to the second request message.

18. The method of claim 15, wherein the first request message and the second request message include different cookies.

19. Physical computer storage having stored thereon instructions that, in response to execution by a computing system having one or more hardware processors, cause the computing system to:
store, in a local data storage, a first response message and a first response identifier corresponding to the first response message, the first response message received during a content transmission over a network between the computing system and a server system having an application;
receive a first request message from an interface of the application;
apply a mapping algorithm to the first request message in order to generate a first request message identifier;
transmit, over the network, the first request message identifier to the server system;
receive the first response message identifier from the server system in response to transmitting the first request message identifier;
obtain the first response message from the local data storage using the first request message identifier; and
communicate the first response message to the application interface.

20. The computer storage of claim 19, having stored thereon instructions that cause the computing system to:
transmit, over the network, the first response message to a peer computing system in communication with the server system, the peer system having a second local data storage;
wherein the peer computing system is configured to update its second local data storage with the first response message.

21. The computer storage of claim 19, having stored thereon instructions that cause the computing system to:
receive, over the network, an update to the first response message from a peer computing system in communication with the server system; and
update the local cache with the update to the first response message;
wherein the computing system responds to a request message corresponding to the first response message with the updated first response message.

22. The computer storage of claim 19, having stored thereon instructions that cause the computing system to:
transmit an update report to the server system, reporting that the first response message has been updated.

23. The computer storage of claim 19, wherein the first response message comprises an HTTP message.
